(19) United States
(12) Patent Application Publication
(10) Pub. No.: US 2022/0277249 A1
(43) Pub. Date: Sep. 1, 2022

(54) BENCHMARKING BASED ON COMPANY VENDOR DATA

(71) Applicant: INTUIT INC., Mountain View, CA (US)

(72) Inventors: Sigalit BECHLER, Bney Zion (IL); Natalie BARELIYAHU, Azur (IL); Guy MAMAN, Hod Hasharon (IL); Daniel ZACH, Karkur (IL); Shlomi MEDALION, Lod (IL)

(21) Appl. No.: 17/187,408

(22) Filed: Feb. 26, 2021

(51) Int. Cl. G06Q 10/06; G06N 20/00; G06F 17/18; G06K 9/62

(52) U.S. Cl. CPC G06Q 10/06393; G06N 20/00; G06F 17/18; G06K 9/6223

(57) ABSTRACT

Certain aspects of the present disclosure provide methods, processing systems, and computer-readable mediums for benchmarking based on company vendor data. Transactions identifying vendors are received for a group of companies whose industry is known. For each identified vendor, a vendor embedding is generated in the form of a vector representing a distribution of transactions for the vendor across industries represented by the companies. For each company, a company embedding is generated in the form of a vector representing an aggregation of vendor embeddings from vendors with which the company has had a transaction. The company embeddings are then clustered using an unsupervised clustering method such as k-Means clustering. For a new company, a company embedding is generated and correlated to the appropriate cluster. Based on the cluster correlated to the new company, data is generated from other companies in the cluster that may be used to benchmark the new company.

### INTRODUCTION

Aspects of the present disclosure relate to data clustering, and more particularly to determining membership within a cluster for inferencing attributes of cluster membership.

Successful business owners seek to understand business data generated through the operation of their business, using this data to measure against industry peers as an indicator of performance and to guide decision making. Business data in this context may include, by way of non-limiting examples, advertising spend, the pendency of receivables, employee retention, employee compensation, cost of goods sold, cost of materials, revenue, and profit. Many additional types of business data that may be useful in developing business decisions and performance metrics will be apparent to one of skill in the art.

Small business owners (SBOs) may not be fully aware of the industry of which they are a part of, or their industry peers. As a result, many small businesses do not correlate a commonly understood industry indicators to their business, such as a North American Industry Classification System (NAICS) code, or provide a high level industry indicator that is too broad in scope to provide useful information to the SBO. Either way, the industry information available to the SBO is very sparse or even non-existent.

With sparse information available on industry peers, data available to the SBO is insufficient for performance benchmarking or decision-making.

What is needed are methods and systems to derive statistically significant industry relevant data for SBO benchmarking and decision making.

### BRIEF SUMMARY

Certain embodiments provide a method that includes receiving a plurality of vendor transactions for each company of a plurality of companies, each vendor transaction identifying a transaction between each respective company of the plurality of companies and one vendor of a plurality of vendors, generating a vendor embedding for each vendor of the plurality of vendors comprising a vector of industry parameters, and generating a company embedding for each company of the plurality of companies, comprising an aggregation of vendor embeddings. The method further includes providing the company embeddings to a clustering algorithm to produce a plurality of industry clusters, correlating a first company to an industry cluster of the plurality of industry clusters, the first company comprising an attribute, aggregating data associated with the attribute for each company in the industry cluster, and display a value of the attribute of the first company relative to the aggregated data of the attribute to a user.

Further embodiments provide a non-transitory computer-readable storage medium storing instructions that include receiving a plurality of vendor transactions for each company of a plurality of companies, each vendor transaction identifying a transaction between each respective company of the plurality of companies and one vendor of a plurality of vendors, generating a vendor embedding for each vendor of the plurality of vendors comprising a vector of industry parameters, and generating a company embedding for each company of the plurality of companies, comprising an aggregation of vendor embeddings. The instructions further include providing the company embeddings to a clustering algorithm to produce a plurality of industry clusters, correlating the first company to an industry cluster of the plurality of industry clusters, the first company comprising an attribute, aggregating data associated with the attribute for each company in the industry cluster, and displaying a value of the attribute of the company relative to the aggregated data of the attribute to a user.

Further embodiments provide a system that includes a memory comprising executable instructions and a processor configured to execute the executable instructions and cause the system to receive a plurality of vendor transactions for each company of a plurality of companies, each vendor transaction identifying a transaction between each respective company of the plurality of companies and one vendor of a plurality of vendors, generate a vendor embedding vector for each vendor of the plurality of vendors comprising a vector of industry parameters, and generate a company embedding vector for each company of the plurality of companies, comprising an aggregation of vendor embedding vectors. The instructions further cause the system to provide the company embedding vectors to a clustering algorithm to produce a plurality of industry clusters correlate a first company to an industry cluster of the plurality of industry clusters, the first company comprising an attributem, aggregate data associated with the attribute for each company in the industry cluster, and display a value of the attribute of the first company relative to the aggregated data of the attribute to a user.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a system for developing benchmarking data based on company vendor data according to certain embodiments.

FIG. 2 depicts a schematic block diagram of a vendor embedding according to certain embodiments.

FIG. 3 depicts a schematic block diagram of a company embedding vector, according to certain embodiments.

FIG. 4 depicts a process of splitting a cluster, according to certain embodiments.

FIG. 5 depicts example clustered data of related companies, according to certain embodiments.

FIG. 6 depicts a method for benchmarking based on company vendor data according to certain embodiments.

FIG. 7 depicts a method for benchmarking based on company vendor data, according to certain embodiments.

FIG. 8 depicts a processing system for benchmarking based on company vendor data, according to certain embodiments.

To facilitate understanding, identical reference numerals have been used, where possible, to designate identical elements that are common to the drawings. It is contemplated that elements and features of one embodiment may be beneficially incorporated into other embodiments without further recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim.

Aspects of the present disclosure provide apparatuses, methods, processing systems, and non-transitory computer-readable mediums for benchmarking based on company vendor data. In certain embodiments, a transaction identifying a vendor is received for a group of companies whose industry is known, for example, from a 4-6 digit NAICS code, a description of company business, or its equivalent. For each identified vendor, a vendor embedding is generated, which in some embodiments is in the form of a vector representing a distribution of transactions for the vendor across industries represented by the companies. A company embedding is generated for each company, which in some embodiments is in the form of a vector representing an aggregation of vendor embeddings with which the company has had a transaction. Company embeddings for the group of companies are then clustered using an unsupervised clustering method, such as k-Means clustering. For a new company, a company embedding is generated and correlated to the appropriate cluster. Based on the cluster to which the new company was correlated, data is generated from other companies in the cluster that may be used to benchmark the new company.

To run a successful business, a business owner must make informed decisions regarding the operation of their business, requiring business data. While even small businesses generate data regarding their operation, this data tends to be quite sparse, making it potentially unreliable for sound business decision making. To increase the body of data available, small businesses have turned to aggregated and anonymized data provided with permission from others, that may be provided by their business management tools such as those sold by Intuit Inc. of Mountain View Calif. under the trademarks QUICKBOOKS™ and QUICKBOOKS ONLINE™, and other business management tools.

If an SBO is able to identify their industry with sufficient detail, these business management tools may be able to provide benchmarking data relevant to the SBO's business from industry peers. In this context, sufficient detail means that the industry of the SBO's business can be identified with particularity. This enables selection of relevant industry peer data from the corpous of data available of businesses that provide data to a business management tool; any such selection is done with the permission of the business that provided the data to the tool, and is provided to the SBO for benchmarking in an anonymized and aggregated form. In some embodiments, a 4-6 digit NAICS code may provide sufficient detail, such as for a computer programming school. The NAICS code 611420 relates to ‘Computer Training’, and other businesses that may be included with this NAICS code, such as software training, LAN management training, and computer operator training. Business management data from each of these types of businesses may be relevant to a computer programming school, and thus use of this code may be relevant. As will be discussed in greater detail below, businesses of these types likely use similar vendors, or vendor types.

In certain embodiments such in the realm of fitness training, there is no NAICS code for yoga, pilates, or CROSSFIT™ studios, and the business management data of each is not particularly relevant to the other. NAICS codes for fitness related businesses would be relevant to gymansiums and businesses offering general fitness facilities, but these would not be particularly relevant to yoga, pilates, or Crossfit studios. In these cases, the actual type of business is the relevant industry, as in each case, fitness studios of these types make up their own segments of fitness generally, and each uses its own vendors or vendor types.

Business owners and particularly SBOs may not always include sufficiently detailed information regarding the industry of which their small business is a part when configuring a financial management tool or reporting to governmental authorities. This may be the result of simply not knowing the particular industry, how to identify the industry with sufficient particularity, or they may provide information identifying an overly broad industry description out of a desire to maintain business breadth of scope.

By way of example, the North American Industry Classification System (NAICS) code system may be used to identify a particular industry of a business when sufficiently detailed codes are provided. For example, a NAICS code for retail is 44, identifying all businesses in the retail trades. The NAICS code for a clothing store is 4481, while a men's clothing store is 448110, a women's clothing store is 448120, and a children's clothing store is 448130. When an SBO doesn't provide an industry identifier (e.g., provides no data for NAICS) or doesn't provide a sufficiently detailed NAICS code (e.g., an NAICS code of 44 for their clothing store), it can be difficult to correlate the SBO's business with peer businesses within the same industry. Although NAICS codes are described herein, this is intended to be one example only. One of skill in the art will be aware of a variety of ways to describe the industry to which a particular business belongs. By way of example, a description of the company's business (e.g., yoga studio or sewing machine repair) sufficiently identifies the industry of the business so that peer businesses may be identified as having relevant business data.

To develop a sufficiently detailed industry description (e.g., identify a sufficiently detailed NAICS code) for a small business, it has been found that the vendors used by a small business may correlate a small business to a particular industry. Using systems and methods disclosed herein, a small business may be identified with an industry group with finer granularity than systems such as NAICS codes. For example, pilates, CROSSFIT™, and yoga fitness centers may be identified with a NAICS code of 611620 “Sports and Recreation Instruction” or “All Other Miscellaneous Schools and Instruction.” By using methods and systems disclosed herein, these businesses are identified as pilates, Crossfit, or yoga fitness centers, which is greater detail than that afforded by the pertinent NAICS code). By enabling such fine-grained industry identification, for example, a yoga studio business may be provided with aggregated and anonymized business data of peer yoga studio businesses so that the SBO will have robust data against which to benchmark her business and make sound business decisions. In this context, business data may include and is not limited to advertising spend, the pendency of receivables, employee retention, employee compensation, cost of goods sold, cost of materials, maintenance costs, equipment costs, revenue, profit, and the like.

According to certain embodiments disclosed herein, a group of industry-known companies for which their industries are known with sufficient particularity is developed. In some embodiments a 4-6 digit NAICS code may be used. In certain embodiments, additional granularity beyond a 6 digit NAICS code may be provided, by sampling company names in an defined industry (such as by a 4-6 digit NAICS code), and selecting common words found in company names. For example, although the NAICS code that yoga studios may fall under is to generic to identify yoga studios, by sampling the names of the companies that fall under such NAICS code will show that the word “yoga” is a common word found in business names for that code. These common words may be used to provide further granularity as to industry or business type, of a given company. Transaction data is gathered from a group of industry-known companies. This transaction data from each industry-known company is used to identify vendors with whom the transactions have occurred.

A vendor embedding is generated as a vector for each vendor that includes an industry element correlated to the industries of the industry-known companies with which the vendor has transacted.

Once a vendor embedding has been generated for each vendor, a company embedding is developed for each industry-identified company. A company embedding is an aggregation of vendor embeddings for a company, based on vendors with whom the company has had at least one transaction. An aggregation in this context may be an average, mean, or other statistical aggregate measure of a group of values.

The company embeddings are provided to an unsupervised clustering algorithm, such as a k-Means algorithm, which in certain embodiments may be a bisecting k-Means algorithm, according to certain embodiments. By providing the company embeddings to the bisecting k-Means algorithm, a number of clusters may be formed, each cluster being a cluster of companies clustered by industry indicated by the clustering algorithm discussed in further detail below.

Once the clusters are formed, a new company for which industry data is not provided, or provided with sufficient detail, may be analyzed. Vendors with which the new company has transacted are identified from transactional data, and vendor embeddings for the identified vendors are used to generate a company embedding for the new company. Based on the company embedding, the new company embedding is used to identify a cluster to which the new company most closely correlates. Anonymized and aggregated business data from the companies identified within the cluster may be utilized to provide benchmarking data for the new company, for performance metrics, and/or serve as the basis for business decisions. The business data from the companies of the cluster are going to be closely related to the new company, and as there may be a statistically relevant number of companies in the cluster, the anonymized and aggregated data set will be robust.

### Example System for Developing Benchmarking Data

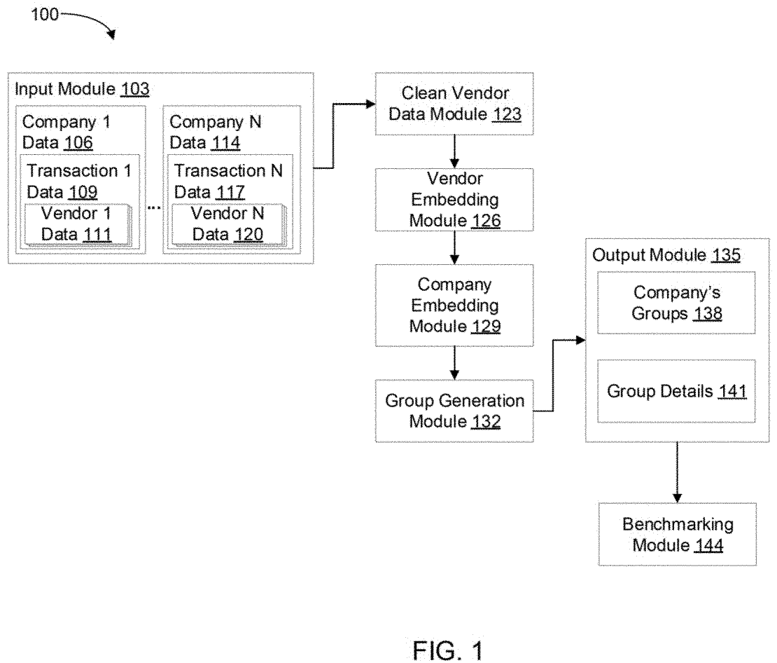

FIG. 1 depicts a system 100 for developing benchmarking data based on company vendor data according to certain embodiments.

System 100 in certain embodiments may be a single computing system such as a desktop, rack-mounted client/server, laptop, mobile, or virtual computer system, with all components operably stored therein, or may have one or more of its components distributed across one or more virtual or physical computer systems.

Input module 103 includes company data for a number of companies, such as Company 1 data 106 through Company N data 114, in some embodiments may be N chosen such that the dataset of company data is considered statistically significant for the type of information provided at the output discussed below. Company 1 through Company N, to which each of company 1 data 106 through Company N data 114 are respectively related to, represent distinct companies. Company 1 through Company N are industry-known companies, that is, the industry(ies) of which Company 1 through Company N are members are known with sufficient detail. In some embodiments a 4-6 digit NAICS code may be used to determine a company's industry. In certain embodiments, a company's industry may be determined outside of using a 6 digit NAICS code, for example by sampling company names in a defined industry (such as by a 4-6 digit NAICS code), and selecting common words found in company names. For example, although the NAICS code that yoga studios may fall under is too generic to identify yoga studios, by sampling the names of the companies that fall under such NAICS code will show that the word “yoga” is a common word found in business names for that code. These common words may be used to identify a company's industry, or provide further granularity as to industry or business type of a given company beyond what an NAICS code may provide. Company data may be stored in any medium suitable, for example, within a database located within or connected to the system 100, or downloaded from other datasources containing this information.

Company data includes transaction data, such as transaction1 data 109 as a component of Company 1 data 106, and transaction N data 117 as a component of Company N data 114. Transaction data in this context includes data relating to multiple transactions with other companies, entities, and vendors with which a company (e.g., Company 1 through Company N) has had one or more transactions, such as financial transactions in exchange for goods or services. Transaction data for a company includes vendor data, that is, data with whom a company has had transactions. Transaction 1 data 109 includes vendor1 data 111, which includes transactional data of a plurality of vendors with which Company 1 has transacted, while Transaction N data 117 includes vendorN data 120, which includes transactional data of a plurality of vendors with which Company N has transacted. Vendor data within company data includes industry data of the vendor and location data of the vendor. In this context, industry of a vendor may be determined as discussed elsewhere herein, such as with NAICS codes and/or sampling of vendor company names identified within a broad industry category such as an NAICS code. A particular vendor may appear in company data of more than one company.

Vendor data from transaction data provided in the input module 103, such as Vendor 1 data 111 through Vendor N data 120, are received by a clean vendor data module 123. At clean vendor data module 123, vendor data received is “cleaned,” or normalized, to facilitate further processing of the vendor data. In certain embodiments, this may include converting all text characters to lower case, removing irrelevant parts from a vendor name, and removing non-letter characters from the vendor name. Other techniques to clean vendor data in this context are known to one of ordinary skill in the art.

Because vendor data will be used, as discussed below, to cluster or otherwise classify a company within a particular industry based on transactions with a particular vendor, at the clean vendor data module 123, vendors that are not sufficiently indicative of membership of a company within an industry are removed. On the one hand, a vendor may not be sufficiently indicative of membership in an industry where the transaction data between companies and the vendor indicates that the companies are from a large number of different industries. For example, consider a parking garage vendor: transaction data from a large number of companies show transactions with this vendor. The number of industries represented by these companies spans a potentially wide range of industries, as the parking garage vendor does not offer a service particular to any one industry or group of related industries. On the other hand, a vendor may only transact with companies representing a few broad industries, such as a clothing manufacturer that is a vendor to companies of the “retail trade” and “wholesale trade” industries. In certain embodiments, vendors whose transaction data indicates that they are not sufficiently indicative of a group of industries are removed from vendor data by the clean vendor data module 123.

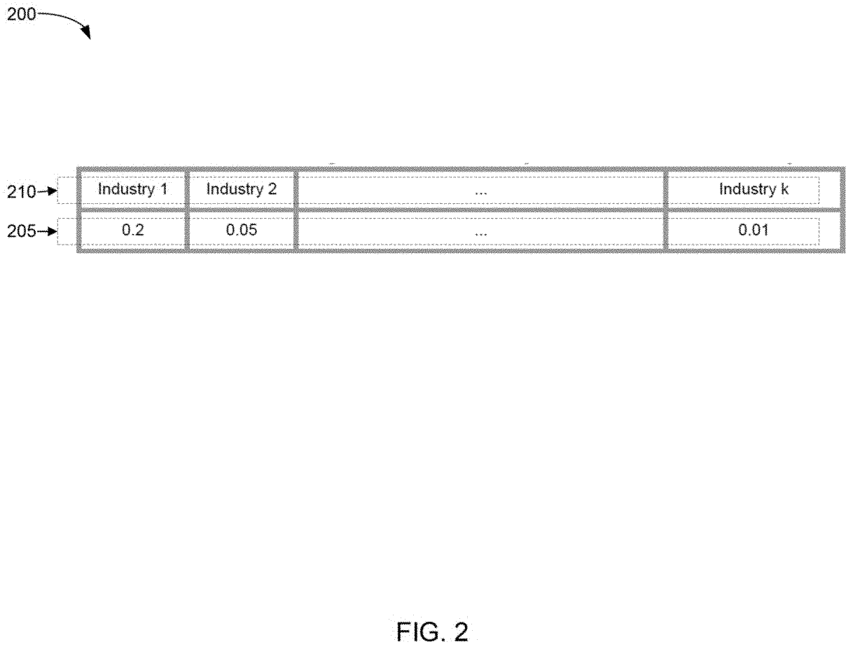

Once the vendor data has been cleaned, it is received by the vendor embedding module 126 to convert vendor data for each vendor to a vector representation. FIG. 2 depicts a schematic block diagram 200 of a vendor embedding according to certain embodiments. As discussed above, vendor data includes the industry of the company with which a vendor has had a transaction, and a vendor may appear in the company data of multiple companies. As a result, for a vendor having transactions with multiple companies, there will be multiple vendor data entries for the vendor, from each company the vendor has had at least one transaction with. As different companies with which a vendor has had transactions may be in a different industry, the different vendor data entries may have different industries indicated.

All vendor data entries for each vendor are aggregated to a vendor embedding vector 205, with each element of the vendor embedding vector 205 indexed to an industry 210. One of skill in the art will appreciate that a vector does not need explicit labels as shown in FIG. 2, which are shown in FIG. 2 for clarity. The resulting vendor embedding vector 205 is a vector of elements, the elements defining a distribution of transactions for a vendor across different industries. A vendor embedding vector 205 is generated for each distinct vendor of the vendor data.

Returning now to FIG. 1, a vendor embedding vector for each distinct vendor of the vendor data is received by a company embedding module 129 to generate a company embedding vector for each company depicted by the company data 106-114, based on vendor embedding vectors of vendors who have transacted with each respective company.

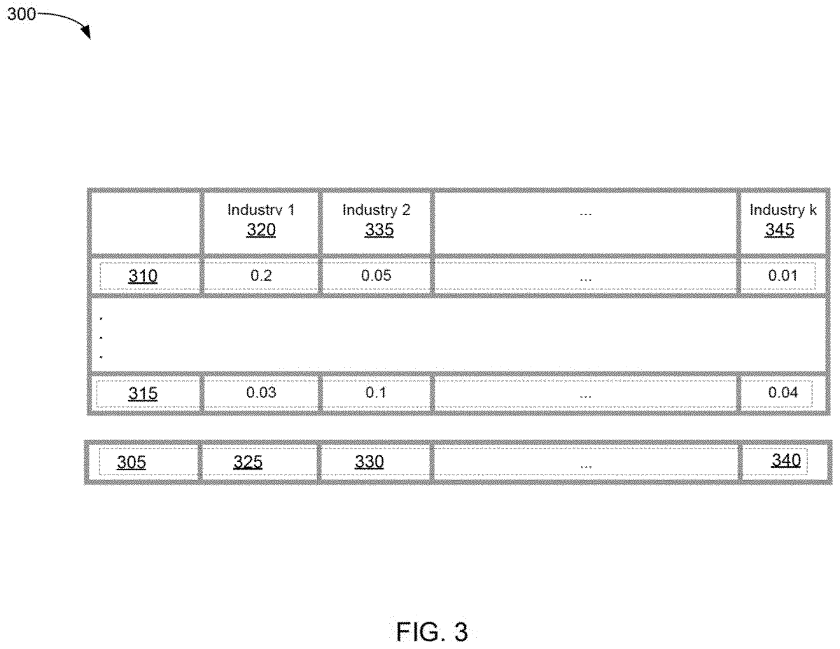

FIG. 3 depicts a schematic block diagram 300 of a company embedding vector 305, according to certain embodiments. A vendor embedding, such as vendor embedding 1 310 through vendor embedding vector N 315, each of which having been developed for each respective vendor in accordance with the discussion of FIG. 2 above, is provided for each vendor with which a company has had at least one transaction. Company embedding vector 305, in certain embodiments, is an aggregation of the values of the vendor embedding vector 1 310 through vendor embedding vector N 315, aggregated on an industry-by-industry basis. In this context, aggregation may be a mean, a median, or other statistical aggregation. For example, for each vendor embedding vector 1-N, the average of all values for an industry 1 320 is determined. Thus, in this example, to first aggregated value 325 for the industry 1 320 element of the company embedding vector 305 would be the mean value of the industry 1 320 values of the vendor embedding vector1 310 through vendor embedding vector N 315. A second aggregated value 330 for industry 2 335 of the company embedding vector 305 would be the mean value of the industry 2 335 values of the vendor embedding vector1 310 through vendor bebedding vector N 315, through an aggregated value K 340 for industry K 345. A company embedding vector, such as company embedding vector 305, is generated for each of Company 1 through Company N.

Returning to FIG. 1, generated company embedding vectors are received by a group generation module 132 to generate company groups based on the industries with which their respective vendors have transactions. In certain embodiments company groups may additionally, or alternatively, be based on the locations of their respective vendors. The received company embedding vectors are placed into a matrix and provided to an algorithm that divides the companies into a plurality of clusters. According to certain embodiments an unsupervised learning algorithm, such as a bisecting k-Means clustering algorithm, may be used to generate the clusters. One of skill in the art will appreciate that other unsupervised clustering methods may be used. In other embodiments, where company embedding vectors include industry labels for each company, a supervised learning algorithm may be used, such as a neural network, logistic regression, support vector machine, or other supervised learning method.

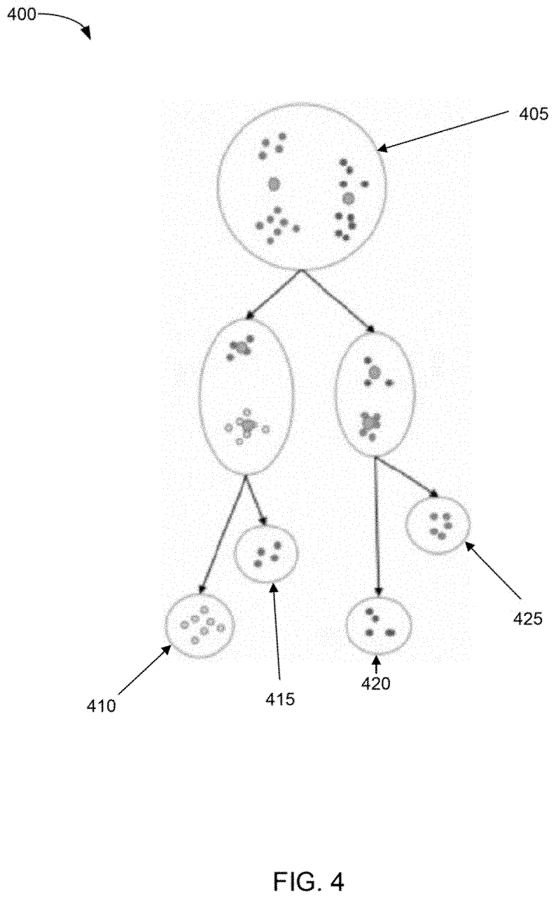

According to certain embodiments, a single centroid (K=1) may be initially selected to develop a single cluster using a K-Means algorithm. After the single cluster is determined, the number of centroids for the cluster is increased to two (K=2) and provided to the k-Means algorithm to return two clusters. FIG. 4 visually depicts a process 400 of splitting or dividing, a cluster, according to certain embodiments. The distance is measured from each data point of a cluster to its centroid. If the sum of the square of the distance from at least one of the data points exceeds a threshold, for example . . . , that cluster is split into two clusters. Splitting is carried out by taking the data set of the cluster to be split or divided, adding a centroid 405 (K=2, for data elements of that cluster), and clustering the data using the k-Means algorithm, which in certain embodiments may be a bisecting k-Means algorithm. This splitting is continued for all clusters until the sum-squared distance for each data point of each cluster is below the threshold, shown by first cluster 410, second cluster 415, third cluster 420, and fourth cluster 425.

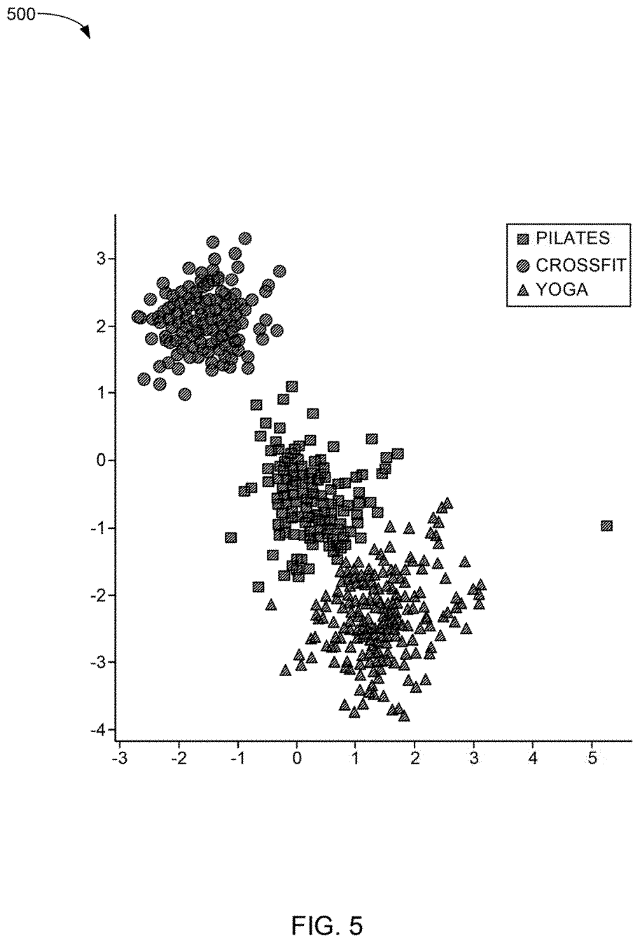

Each cluster below the threshold defines a group of companies in a particular industry, with sufficient granularity so that aggregated and anonymized data from the group of companies may be relevant to another company identified as a member of the cluster, for example, as benchmarking data or data upon which a reasonable business decision may be made. FIG. 5 depicts an example 500 of clustered data of related companies, around particular industries, according to certain embodiments. Although the examples depicted in FIG. 5 show industry granularity to the actual businesses of the companies of each cluster (i.e., pilates studio, Crossfit gym, yoga studio), in other embodiments, data granularity may be related to the NAICS code system, for example to a 5 or 6 digit NAICS code.

Returning back to FIG. 1, once the clusters have been developed as discussed above, they are received by output module 135 to determine an industry for a company for whose industry is not known or not known with sufficient detail. For a new company, a company embedding is developed based on previously determined vendor embeddings of its vendors. The new company embedding is used to determine which company's groups 138, or industry clusters, that that the new company is a member of, based on the new company's vendors. Once the new company is placed in a group, group details 141 may be developed from anonymized and aggregated data from the group members that may be used by the new company by a benchmarking module 144. As discussed above, information from the company's group 138 in the group details 141 used by the benchmarking module 144 may include and is not limited to advertising spend, the pendency of receivables, employee retention, employee compensation, cost of goods sold, cost of materials, maintenance costs, equipment costs, revenue, profit, and the like. Group details 141 in certain embodiments includes industry data derived from the vendor embeddings and/or company embeddings, that may be used to define an industry for a given cluster. For example, if a number of vendors infer a given cluster have the words “women,” “casual,” and “clothing”, then that cluster group detail may include an industry type of “womens causal clothing.” Moreover group details 141 may include location data derived from vendor embeddings. For example, if a statistically significant number of vendors that infer a given cluster can be identified with a particular geographical region, that cluster group detail 141 may be further defined by that region.

### Example Method for Benchmarking Based on Company Vendor Data

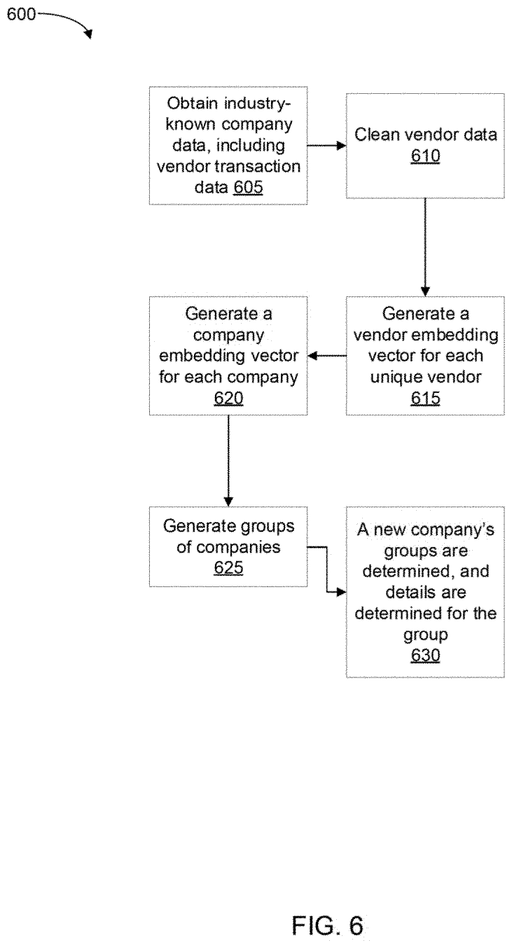

FIG. 6 depicts a method 600 for benchmarking based on company vendor data according to certain embodiments.

At 605, the method obtains company data for a plurality of companies whose industry is known. In certain embodiments, an industry (or industries) for a company may be known if described with at least a four-digit NAICS code, while in other embodiments, the actual type of business is known (e.g., a Pilates studio vs. a “sports and recreation instruction” from a NAICS code). For each company, transaction data is received indicating transactions with multiple vendors used by the company. In certain embodiments, one or more vendors may be used by many companies, as indicated by the presence of these vendors in the vendor data of multiple companies. Company data may be like Company 1 Data 106 through Company N data 114 of FIG. 1.

At 610, the method cleans vendor data in preparation for subsequent processing discussed below. In certain embodiments, all text characters are converted to lower case characters, and numerical characters may be removed. In some embodiments, vendor data of particular vendors may relate to too many industries that have little to no semantic relationship to each other, such as a parking garage that has transactions with a diverse array of companies. In certain embodiments, vendor data for a vendor having little or no semantic relationship between companies with which the vendor has transactions is not used. In certain embodiments, vendor data of some vendors may show a relationship with companies whose industries are too broad (i.e., “wholesale trade”) and removed from the vendor data. This operation may occur similar to that described in connection with the clean vendor data module 123 of FIG. 1.

At 615, the method generates a vendor embedding vector for each unique vendor of the known company data, similar to the discussion above in connection with the vendor embedding module 126 of FIG. 1. In certain embodiments, the vendor embedding vector is a vector representing a distribution of transactions that each vendor has, indexed by industries, and in certain embodiments may include vendor location data.

At 620, the method generates a company embedding vector for a company by aggregating vendor embedding vectors for each vendor with which the company has had transactions. A company embedding vector is generated in this manner for each company for which company data is provided, according to certain embodiments. Company embedding vectors may be generated in a manner as discussed above in connection with company embedding module 129 of FIG. 1.

At 625, the method generates groups of companies. Company embeddings are provided to a bisecting k-Means clustering algorithm to develop industry clusters, or groups, of companies based on the industries served by their respective vendors as represented in the vendor embeddings. In certain embodiments the clusters may additionally, or alternatively, be based on location in that a companies may be clustered based on the location of their vendors. In certain embodiments, initially, one centroid is provided, and a cluster developed. The distance from each member of the cluster is measured, and if there is at least one member having a distance from the centroid that exceeds a threshold, the number of centroids is increased by one and provided to the k-Means clustering algorithm for the development of additional clusters. In certain embodiments, this process is iteratively carried out until no member of a cluster exceeds a distance from its centroid by the threshold. This may be similar to the description above in connection with group generation module 132 of FIG. 1.

At 630, a new company's groups are determined, and details, such as business data, is determined for the group, which may be similar to output module 135 of FIG. 1. A new company in this context is a company for which business-relevant data and/or benchmarking data is needed, but the new company's industry is not known or not known with sufficient detail. Company data for the new company is obtained, and vendor data for the new company's vendors are identified. A new company embedding vector is generated as discussed above, using vendor embedding vectors for identified vendors that have previously had vendor embedding vectors generated as discussed above. The new company embedding vector is identified as being a member of a previously generated group (e.g., cluster) from 625. In certain embodiments, the new company embedding vector may be processed using a k-Means clustering algorithm, which in certain embodiments is a bisecting k-Means algorithm, to identify the cluster, or group, that the new company is a member of. Based on the group membership, group details are determined, such as developing aggregated and anonymized data for the group comprising advertising spend, the pendency of receivables, employee retention, employee compensation, cost of goods sold, cost of materials, maintenance costs, equipment costs, revenue, profit, and the like. One or more of these values may be displayed to a user, comparing the group data to the relevant data of the new company to serve as a basis for business decision making. These details may be provided to benchmark the new company in a meaningful way, as the data from the group will be highly relevant to the new company.

### Example Method for Benchmarking Based on Company Vendor Data

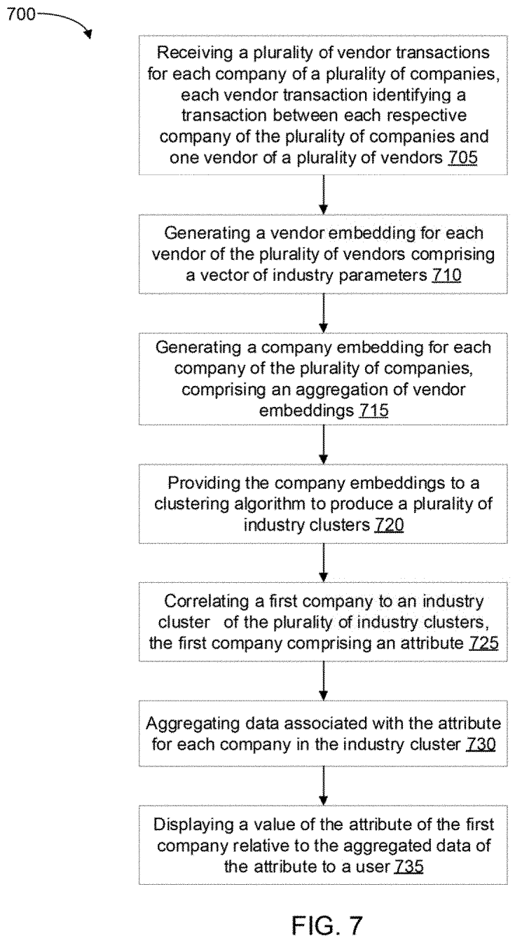

FIG. 7 depicts a method 700 for benchmarking based on company vendor data, according to certain embodiments.

At 705, the method 700 receives a plurality of vendor transactions for each company of a plurality of companies, each vendor transaction identifying a transaction between each respective company of the plurality of companies and one vendor of a plurality of vendors.

At 710, the method 700 generates a vendor embedding vector for each vendor of the plurality of vendors comprising a vector of industry parameters.

At 715, method 700 generates a company embedding vector for each company of the plurality of companies, comprising an aggregation of vendor embeddings. In certain embodiments, the vector of industry parameters comprises a distribution of industries with which the vendor has had at least one transaction. In certain embodiments, the company embedding vector for each respective company of the plurality of companies includes one or more vendor embedding vectors for vendors with which the respective company has had at least one transaction comprises one of an average, a median, and a mode.

At 720, the method 700 provides the company embedding vectors to a clustering algorithm to produce a plurality of industry clusters.

At 725, method 700 correlates a first company to an industry cluster of the plurality of industry clusters, the first company comprising an attribute. In certain embodiments, the clustering algorithm is an unsupervised machine learning algorithm, and in some embodiments, the clustering algorithm is a k-Means clustering algorithm, which in some embodiments may be a bisecting k-Means algorithm.

In certain embodiments, the method 700 further includes dividing at least one cluster generated by the clustering algorithm into at least two clusters, the dividing including measuring a distance from each member in the at least one cluster to a centroid of the cluster, adding a second centroid to the cluster when the distance measured from at least one member exceeds a threshold, and generating two clusters by providing each member of the at least one cluster, the centroid, and the second centroid, to the clustering algorithm.

In certain embodiments, correlating the first company to the industry cluster comprises generating a first company embedding vector for the first company and measuring a distance from the first company embedding vector endpoint to a center of a centroid of the industry cluster.

At 730, the method 700 aggregates data associated with the attribute for each company in the industry cluster.

At 735, the method 700 displays a value of the attribute of the first company relative to the aggregated data of the attribute to a user.

### Example Processing System

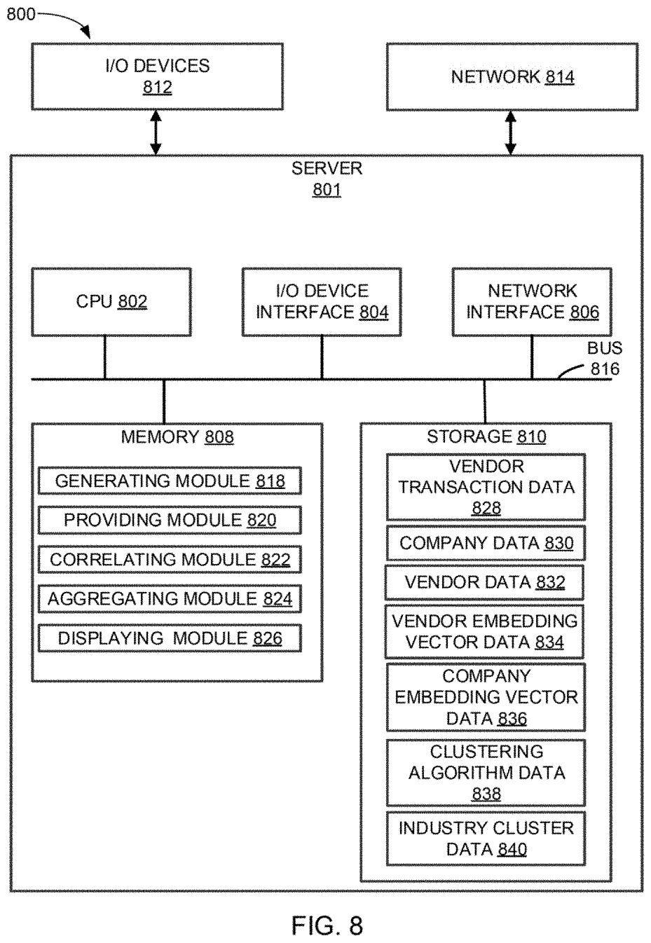

FIG. 8 depicts a processing system 801 for benchmarking based on company vendor data, according to certain embodiments, that may perform methods herein, such as the methods described in connection with FIGS. 6 and 7.

Processing system 801 includes a central processing unit (CPU) 802 connected to a data bus 816. CPU 802 is configured to process computer-executable instructions, e.g., stored in memory 808 or storage 810, and to cause the processing system 801 to perform methods described herein, for example, with respect to FIGS. 6 and 7. CPU 802 is included to be representative of a single CPU, multiple CPUs, a single CPU having multiple processing cores, and other forms of processing architecture capable of executing computer-executable instructions.

Processing system 801 further includes input/output (I/O) device(s) 812 and interfaces 804, which allows processing system 801 to interface with input/output devices 812, such as, for example, keyboards, displays, mouse devices, pen input, and other devices that allow for interaction with processing system 801. Note that processing system 801 may connect with external I/O devices through interfaces 804, which may be physical or wireless connections.

Processing system 801 further includes a network interface 806, which provides processing system 801 with access to external network 814 and thereby external computing devices.

Processing system 801 further includes memory 808, which in this example includes a generating module 818, providing module 820, correlating module 822, aggregating module 824, and displaying module 826 for performing operations described in FIGS. 6 and 7.

Note that while shown as a single memory 808 in FIG. 8 for simplicity, the various aspects stored in memory 808 may be stored in different physical memories, including memories remote from processing system 801, but all accessible by CPU 802 via internal data connections such as bus 816.

Storage 810 further includes vendor transaction data 828, which may be like transaction data described in connection with FIGS. 6 and 7.

Storage 810 further includes company data 830, which may be like company data as described in connection with FIGS. 6 and 7.

Storage 810 further includes vendor data 832, which may be like information related to vendors as described in connection with FIGS. 6 and 7.

Storage 810 further includes vendor embedding vector data 834, which may be like vendor embedding vectors described in connection with FIGS. 6 and 7.

Storage 810 further includes company embedding vector data 836, which may be like company embedding vectors described in connection with FIGS. 6 and 7.

Storage 810 further includes clustering algorithm data 838, which may be like the clustering algorithm described in connection with FIGS. 6 and 7.

Storage 810 further includes industry cluster data 840, which may be like the industry clusters, or groups, described in connection with FIGS. 6 and 7.

While not depicted in FIG. 8, other aspects may be included in storage 810.

As with memory 808, a single storage 810 is depicted in FIG. 8 for simplicity, but various aspects stored in storage 810 may be stored in different physical storages, but all accessible to CPU 802 via internal data connections, such as bus 816 or external connection, such as network interfaces 806. One of skill in the art will appreciate that one or more elements of server 801 may be located remotely and accessed via a network 814.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in figures, those operations may have corresponding counterpart means-plus-function components with similar numbering.

The following claims are not intended to be limited to the embodiments shown herein but are to be accorded the full scope consistent with the language of the claims. Within a claim, a reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving a plurality of vendor transactions for each company of a plurality of companies, each vendor transaction identifying a transaction between each respective company of the plurality of companies and one vendor of a plurality of vendors;
generating a vendor embedding vector for each vendor of the plurality of vendors comprising a vector of industry parameters;
generating a company embedding vector for each company of the plurality of companies, comprising an aggregation of vendor embedding vectors;
providing the company embedding vectors to a clustering algorithm to produce a plurality of industry clusters;
correlating a first company to an industry cluster of the plurality of industry clusters, the first company comprising an attribute;
aggregating data associated with the attribute for each company in the industry cluster; and
displaying a value of the attribute of the first company relative to the aggregated data of the attribute to a user.

2. The method of claim 1, wherein the vector of industry parameters comprises a distribution of industries with which the vendor has had at least one transaction.

3. The method of claim 2, wherein the company embedding vector for each respective company of the plurality of companies includes one or more vendor embedding vectors for vendors with which the respective company has had at least one transaction comprises one of an average, a median, and a mode.

4. The method of claim 1, wherein the clustering algorithm is an unsupervised machine learning algorithm.

5. The method of claim 4, wherein the clustering algorithm is a K-means clustering algorithm.

6. The method of claim 5, further comprising:
dividing at least one cluster generated by the clustering algorithm into at least two clusters, the dividing comprising:
measuring a distance from each member in the at least one cluster to a centroid of the cluster;
adding a second centroid to the cluster when the distance measured from at least one member exceeds a threshold; and
generating two clusters by providing each member of the at least one cluster, the centroid, and the second centroid, to the clustering algorithm.

7. The method of claim 1, wherein correlating the first company to the industry cluster comprises generating a first company embedding vector for the first company and measuring a distance from the first company embedding vector to a center of a centroid of the industry cluster.

8. A non-transitory computer-readable storage medium storing instructions that, when executed by a processor of a processing system, cause the processing system to perform a method, the method comprising:
receiving a plurality of vendor transactions for each company of a plurality of companies, each vendor transaction identifying a transaction between each respective company of the plurality of companies and one vendor of a plurality of vendors;
generating a vendor embedding vector for each vendor of the plurality of vendors comprising a vector of industry parameters;
generating a company embedding vector for each company of the plurality of companies, comprising an aggregation of vendor embedding vectors;
providing the company embedding vectors to a clustering algorithm to produce a plurality of industry clusters;
correlating a first company to an industry cluster of the plurality of industry clusters, the first company comprising an attribute;
aggregating data associated with the attribute for each company in the industry cluster; and
displaying a value of the attribute of the company relative to the aggregated data of the attribute to a user.

9. The non-transitory computer-readable storage medium of claim 8, wherein the vector of industry parameters comprises a distribution of industries with which the vendor has had at least one transaction.

10. The non-transitory computer-readable storage medium of claim 9, wherein the company embedding vector for each respective company of the plurality of companies includes one or more vendor embedding vectors for vendors with which the respective company has had at least one transaction comprises one of an average, a median, and a mode.

11. The non-transitory computer-readable storage medium of claim 8, wherein the clustering algorithm is an unsupervised machine learning algorithm.

12. The non-transitory computer-readable storage medium of claim 11, wherein the clustering algorithm is a K-means clustering algorithm.

13. The non-transitory computer-readable storage medium of claim 12, wherein the method further comprises:
dividing at least one cluster generated by the clustering algorithm into at least two clusters, the dividing comprising:
measuring a distance from each member in the at least one cluster to a centroid of the cluster;
adding a second centroid to the cluster when the distance measured from at least one member exceeds a threshold; and
generating two clusters by providing each member of the at least one cluster, the centroid, and the second centroid, to the clustering algorithm.

14. The non-transitory computer-readable storage medium of claim 8, correlating the first company to the industry cluster comprises generating a first company embedding vector for the first company and measure a distance from the first company embedding vector to a center of a centroid of the industry cluster.

15. A system, comprising:
a memory comprising executable instructions;
a processor configured to execute the executable instructions and cause the system to:
receive a plurality of vendor transactions for each company of a plurality of companies, each vendor transaction identifying a transaction between each respective company of the plurality of companies and one vendor of a plurality of vendors;
generate a vendor embedding vector for each vendor of the plurality of vendors comprising a vector of industry parameters;
generate a company embedding vector for each company of the plurality of companies, comprising an aggregation of vendor embedding vectors;
provide the company embedding vectors to a clustering algorithm to produce a plurality of industry clusters;
correlate a first company to an industry cluster of the plurality of industry clusters, the first company comprising an attribute;
aggregate data associated with the attribute for each company in the industry cluster; and
display a value of the attribute of the first company relative to the aggregated data of the attribute to a user.

16. The system of claim 15, wherein the vector of industry parameters comprises a distribution of industries with which the vendor has had at least one transaction.

17. The system of claim 16, wherein the company embedding vector for each respective company of the plurality of companies is based on one or more vendor embedding vectors for vendors with which the respective company has had at least one transaction comprises one of an average, a median, and a mode.

18. The system of claim 15, wherein the clustering algorithm is an unsupervised machine learning algorithm.

19. The system of claim 18, wherein the clustering algorithm is a K-means clustering algorithm.

20. The system of claim 19, wherein the processor is further configured to cause the system to:
divide at least one cluster generated by the clustering algorithm into at least two clusters, the dividing comprising:
measure a distance from each member in the at least one cluster to a centroid of the cluster;
add a second centroid to the cluster when the distance measured from at least one member exceeds a threshold; and
generate two clusters by providing each member of the at least one cluster, the centroid, and the second centroid, to the clustering algorithm.
